(19) United States
(12) Patent Application Publication
(10) Pub. No.: US 2011/0131145 A1
(43) Pub. Date: Jun. 2, 2011

(54) Measuring engagement activities initiated by electronic word-of mouth referrals in social networks

(76) Inventors: Harry R. Soza, San Jose, CA (US); Mark Wayman, Oakland, CA (US); Keith Rose, Alamo, CA (US); Jeffrey A. Roberts, Hayward, CA (US)

(21) Appl. No.: 12/924,925

(22) Filed: Oct. 8, 2010

Related U.S. Application Data
(63) Continuation-in-part of application No. 12/288,614, filed on Oct. 21, 2008.
Application No. 12/288,614 is a continuation-in-part of application No. 12/460,223, filed on Jul. 14, 2009.
Application No. 12/460,223 is a continuation-in-part of application No. 12/804,248, filed on Jul. 16, 2010.
(60) Provisional application No. 61/278,678, filed on Oct. 8, 2009.

(51) Int. Cl. G06Q 99/00

(52) U.S. Cl. 705/319

(57) ABSTRACT

A system is provided for assessing the historical engagement activities of a single user, and then altering the current presentation of engagement activities in accordance with a predetermined sequential series, or an algorithmic decision-tree, so that an optimized set of engagement options are presented to returning or recurring users. This system is capable of weighting each of the various engagement activities that have been clicked on by an individual, calculating an overall “engagement score”, and then presenting certain engagement activities based on that factor.

### CROSS-REFERENCE TO RELATED APPLICATIONS

This application claims priority from U.S. Provisional Patent Application 61/278,678 filed Oct. 8, 2009, which is incorporated herein by reference. This application is a continuation-in-part of U.S. patent application Ser. No. 12/288,614 filed Oct. 21, 2008, which is incorporated herein by reference. This application is also a continuation-in-part of U.S. patent application Ser. No. 12/460,223 filed Jul. 14, 2009, which is incorporated herein by reference. This application is also a continuation-in-part of U.S. patent application Ser. No. 12/804,248 filed Jul. 16, 2010, which is incorporated herein by reference.

### FIELD OF THE INVENTION

The invention relates generally to online promotions in social network systems. More particularly, the invention relates to computer-based systems and methods of tracking and measuring engagement activities initiated by electronic word-of-mouth referrals in social network systems.

### BACKGROUND OF THE INVENTION

The core dynamics of a social network is the communication between individuals who regards each other as some type of friend or personal acquaintance. At times, this communication involves an electronic discussion about some form of business promotion, such as a sale, special event, new model etc. For the business sponsoring the promotion, this discussion is a highly valuable form of word-of-mouth marketing which is enabled and accelerated by Internet technology.

### SUMMARY OF THE INVENTION

This invention involves a technology system capable of assessing the historical engagement activities of a single user, and then altering the current presentation of engagement activities in accordance with a predetermined sequential series, or an algorithmic decision-tree, so that an optimized set of engagement options are presented to returning or recurring users. This technology system is capable of weighting each of the various engagement activities that have been clicked on by an individual, calculating an overall “engagement score”, and then presenting certain engagement activities based on that factor.

### DESCRIPTION OF THE INVENTION

By originating the electronic word-of-mouth discussion, for example by sending a message to a friend, each individual is making a selection about which of their friends would want to hear about the promotion. This selection is a type of highly effective targeting based on information and perceptions not readily available to any outsider. Further in telling a friend about a specific promotion there is an implied testimonial by the sender regarding the value and validity of the promotion. Accordingly, for the sponsoring business, the sending of information (also referred to as viral spread) is a form of extraordinary well-targeted marketing.

When a recipient of a message responds or clicks a link to learn more about a promotion, they are confirming a level of interest in the topic of that promotion. This response action can be thought of as the social networking analog of a search engine. By responding to a message from a friend, the individual is demonstrating that the topic is of interest, timely, and currently relevant to them.

Businesses regard these types of potential customers very highly. A potential customer that presents this “interest profile” could be an opportunity for the sponsoring business to develop a more extensive business relationship such as product feedback, frequent buyer programs, loyalty offers, or the like. The sponsoring business has the chance to offer various engagement activities to the individual beyond the promotion link.

To understand which engagement activities are most effective, a sponsoring business needs a technology system that can track and record the activity of the individuals with regards to electronic word-of-mouth viral spread and the engagement activities provided by the sponsoring business.

Embodiments of the invention involve a computer implemented system capable of identifying those users who, by clicking a link contained in an email message sent to them by a friend, arrive at a web page, within a social network, that is sponsored information.

Embodiments of the invention further involve a computer implemented system capable of offering to a user a variety of web-page based engagement activities such as:
Get a product sample
Take a survey
Video—watch and comment
Instant polls
RSVP to an event
e-newsletter sign-up
Vote for favorite
Make donation
Join insider club
Or the like,

The computer system is capable of supporting and recording all input from the individuals and could use data associated with these type of engagement activities. The system may also offer transactional and sharing activities to the individuals.

Embodiments of the invention further involve a computer implemented system capable of tracking the activity of an individual across various engagement activities, transactional and sharing activities that are offered. The tracking of engagement activities can be done separately or in addition with the tracking of the sharing activity as taught in, for example, U.S. patent application Ser. No. 12/288,614 filed on Oct. 21, 2008 and U.S. patent application Ser. No. 12/460,223 filed on Jul. 14, 2009, which are both incorporated by reference to this patent application in its entirety.

Embodiments of the invention further involve a data analysis system capable of assessing the quality and effectiveness of specific activities, or certain sets of activities, based on recorded patterns of consumer use or responses.

Embodiments of the invention further involve a computer implemented system capable of maintaining a database of users/individuals who have been identified as having greater “influence” in specific domains, and whereby the system is capable of tracking the degree of their interest and receptiveness to specific engagement activities.

Embodiments of the invention further involve a computer implemented system capable of calculating and assigning certain “performance factors” to aggregate statistics and thereby characterize the performance of specific business promotions.

The technology for tracking and determining influence has been described in, for example, U.S. patent application Ser. No. 12/288,614 filed on Oct. 21, 2008 and U.S. patent application Ser. No. 12/460,223 filed on Jul. 14, 2009, which are both incorporated by reference to this patent application in its entirety.

Further details of embodiments of the invention are described in Appendix A (a paper (4 pages) by the inventors), which is hereby incorporated in its entirety.

1. A system for spreading engagement activities into a social network environment, comprising:
(a) a first communication network system being a social network communication system with a plurality of social network members and friends;
(b) a second communication network system being a communication network outside said social network communication system; and
(c) a user of said second communication network having an electronic communication containing an engagement activity;
(d) said user initiating a first electronic communication from said second communication network system to inside said first communication network system, wherein said user is a member of said social network communication system and has connections to social network friends in said social network communication system;
(e) further communicating in a second electronic communication said engagement activity to said social network friends;
(f) each of said friends capable of initiating a third electronic communication from said first communication network to the friends of each of said friends in said social network communication system; and
(g) a computer server system monitoring information associated with said engagement activity and said first, second and third communication steps.
